(19) United States
(12) Patent Application Publication
(10) Pub. No.: US 2006/0103599 A1
(43) Pub. Date: May 18, 2006

(54) Plasma display panel apparatus and driving method thereof

(76) Inventors: Ki Duck Cho, Changwon-si (KR); Min Soo Kim, Gumi-si (KR); Won Jae Kim, Masan-si (KR); Kyoung Jin Jung, Gumi-si (KR)

Correspondence Address: FLESHNER & KIM, LLP, P.O. BOX 221200, CHANTILLY, VA, 20153, US

(21) Appl. No.: 11/266,473

(22) Filed: Nov. 4, 2005

(30) Foreign Application Priority Data
Nov. 5, 2004 (KR) 10-2004-0090048

(51) Int. Cl. G09G 3/28

(52) U.S. Cl. 345/67

(57) ABSTRACT

A plasma display panel apparatus and its driving method are disclosed. When temperature of a panel or an ambient temperature of the panel is higher than a reference temperature, the number of reset rising waveforms applied during one frame is increased. Accordingly, degradation of the panel contrast according to a set-up discharge can be prevented, and a discharge can stably occur at a high temperature.

### BACKGROUND OF THE INVENTION

1. Field of the Invention

The present invention relates to a plasma display panel apparatus and a driving method thereof and, more particularly, to a plasma display panel apparatus and its driving method capable of ensuring a stable discharge even when temperature of a panel or a driving circuit increases by applying a different driving waveform according to temperature.

2. Description of the Related Art

A plasma display device is a device in which discharge cells are formed between a rear substrate with barrier ribs formed thereon and an front substrate facing the rear substrate, and when an inert gas inside each discharge cell is discharged by a high frequency voltage, vacuum ultraviolet rays are generated to illuminate phosphor to thereby allow displaying of images.

FIG. 1 is a perspective view illustrating the structure of a general plasma display panel.

First, discharge cells are formed by a plurality of barrier ribs 24 separating a discharge space on a rear substrate 18 facing a front substrate 10.

An address electrode (X) is formed on the rear substrate 18, and a scan electrode (Y) and a sustain electrode (Z) are formed as a pair on the front substrate 10. The address electrode (X) crosses the other electrodes (Y and Z).

A dielectric layer 22 for accumulating wall charges is formed on the rear substrate 18 with the address electrode (X) formed thereon.

Barrier ribs 24 are formed on the dielectric layer 22 to define a discharge space therebetween and prevent a leakage of ultraviolet rays and visible light generated by a discharge to an adjacent discharge cell. A phosphor 26 is coated on the surface of the dielectric layer 22 and on the surface of the barrier ribs 24.

Because an inert gas is injected into the discharge space, the phosphor 26 is excited by the ultraviolet rays generated during a gas discharge to generate one of red, green and blue visible light.

The scan electrode (Y) and the sustain electrode (Z) formed on the front substrate 10 include transparent electrodes 12Y and 12Z and bus electrodes 13Y and 13Z, respectively, and cross the address electrode (X). A dielectric layer 14 and a protective film 16 are formed to cover the scan electrode (Y) and the sustain electrode (Z).

The discharge cell with such a structure is selected by a facing discharge formed between the address electrode (X) and the scan electrode (Y), and a discharge is sustained by a surface discharge between the scan electrode (Y) and the sustain electrode (Z), to thus emit visible light.

The scan electrode (Y) and the sustain electrode (Z) include the transparent electrodes 12Y and 12Z and the bus electrodes 13Y and 13Z having the smaller width than the transparent electrode 12a and formed on one edge portion of the transparent electrodes 12Y and 12Z, respectively.

FIG. 2 is a view showing one frame of the general plasma display panel and FIG. 3 is a driving waveform view of the general plasma display panel.

With reference to FIG. 2, in the plasma display panel, in order to represent a gray level of an image, one frame is divided into several sub-fields (SF1 to SF8) each having a different number of times of illumination and driven according to time division. Each sub-field (SF1-SF8) includes a reset period (R) for initializing wall charges within the discharge cell, an address period (A) for selecting a scan line and then selecting a discharge cell from the selected scan line, and a sustain period (S) for implementing a gray level according to the number of times that a sustain discharge occurs.

Gray levels implemented in the sub-fields including the reset period (R), the address period (A) and the sustain period (S) are accumulated during one period, and in case where an image is represented with 256 gray levels, as shown in FIG. 2, a frame period corresponding to 1/60 seconds is divided into eight sub-fields (SF1 to SF8) and each sub-field represents 2ⁿ (n=0, 1, 2, 3, 4, 5, 6, 7) gray levels.

A driving waveform in a sub-field will now be described with reference to FIG. 3. As for a reset waveform supplied to the scan electrode (Y), the reset period (R) includes a period (SU) during which a set-up waveform (RU) rising in a ramp form is supplied and a period (SD) during which a set-down waveform (RF) falling in the ramp form is supplied. As a voltage of the panel is increased by the set-up waveform (RU), a reset discharge occurs and wall charges are formed on the dielectric layer 14. And, as the voltage of the panel is dropped by the set-down waveform (RD), some unnecessary wall charges are erased.

During the address period (A), a negative scan pulse (SCP) is sequentially applied to the scan electrodes (Y), and simultaneously, a positive data pulse (DP) is applied to the address electrode (X). As a voltage difference between the scan pulse (SCP) and the data pulse (DP) and the wall charges generated during the reset period are added, an address discharge occurs in the cell where the data pulse (DP) is applied.

During the sustain period (S), a sustain pulse (SP) is alternately applied to the scan electrode (Y) and the sustain electrode (Z), and a sustain discharge occurs in a surface discharge form according to a voltage difference between the scan electrode (Y) and the sustain electrode (Z).

In the related art plasma display panel driven (operated) in this manner, an image is displayed during the sustain period (S) corresponding to gray levels of the sub-fields, but because light according to a setup discharge is also displayed even during the reset period (R), a desired gray level cannot be represented and thus the contrast is degraded.

In addition, the related art plasma display panel apparatus is malfunctioned when it is driven (operated) at a high temperature of 40° C. or higher.

In more detail, when the plasma display panel is driven (operated) at the high temperature, insulation characteristics of the dielectric material and the protection layer material within the discharge cell are degraded to generate a leakage current, and the wall charges generated according to the setup discharge are damaged (lost) due to the leakage current, so the next address discharge cannot normally occurs, making an erroneous discharge.

### SUMMARY OF THE INVENTION

The present invention is designed to solve such a problem of the related art, and therefore, an object of the present invention is to provide a plasma display panel apparatus and its driving method capable of ensuring a stable discharge even when temperature of a panel or a driving circuit increases by applying a different driving waveform according to temperature.

To achieve the above object, there is provided a method of driving a plasma display panel including increasing the number of reset rising waveforms applied during one frame when at least one of temperature of a panel and an ambient temperature of the panel increases.

If a sensed temperature value is smaller than a certain reference temperature, the reset rising waveform is supplied only to a single sub-field of one frame, and the reset rising waveform is supplied during a reset period of a first sub-field included in one frame.

Only a reset falling waveform is applied to the other remaining sub-fields than the sub-field to which the reset rising waveform is applied, and falls at a high potential of the last sustain waveform of a preceding sub-field.

If the sensed temperature value exceeds the certain reference temperature value, a first reset rising waveform and a second reset rising waveform are applied to at least two or more sub-fields during one frame, respectively.

In this case, the first reset rising waveform may be applied during the first sub-field and the second reset rising waveform may be applied during the sub-field that follows the sub-field representing the highest gray level, among the sub-fields included in one frame.

In addition, the first reset rising waveform may have a voltage value higher than that of the second reset rising waveform, and only the reset falling waveform is applied during the other remaining sub-fields than the sub-field to which the reset rising waveform is applied.

To achieve the above object, there is also provided a plasma display panel apparatus including a scan driver for increasing the number of reset rising waveforms applied during one frame when either temperature of a panel or an ambient temperature of the panel is higher than a certain reference temperature, so that the number of the reset rising waveforms can be greater than that of a case where the temperature of the panel or the ambient temperature of the panel is not higher than the reference temperature level.

Accordingly, when the plasma display panel is driven (operated) at a high temperature, since the reset rising waveform is additionally applied, a loss of wall charges according to a leakage current can be compensated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing the structure of a discharge cell of a three-electrode AC surface discharge type plasma display panel in accordance with a related art.

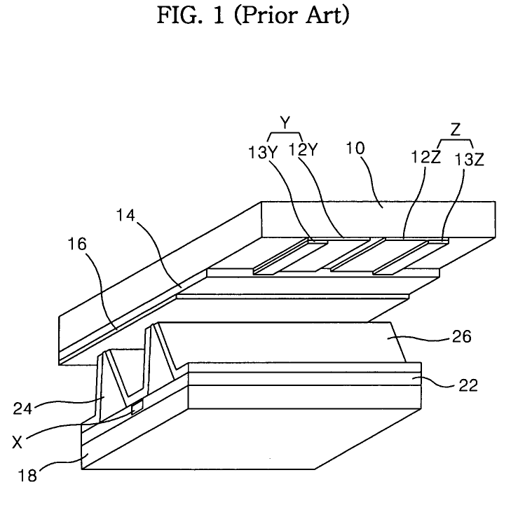

FIG. 2 illustrates one frame of a general plasma display panel.

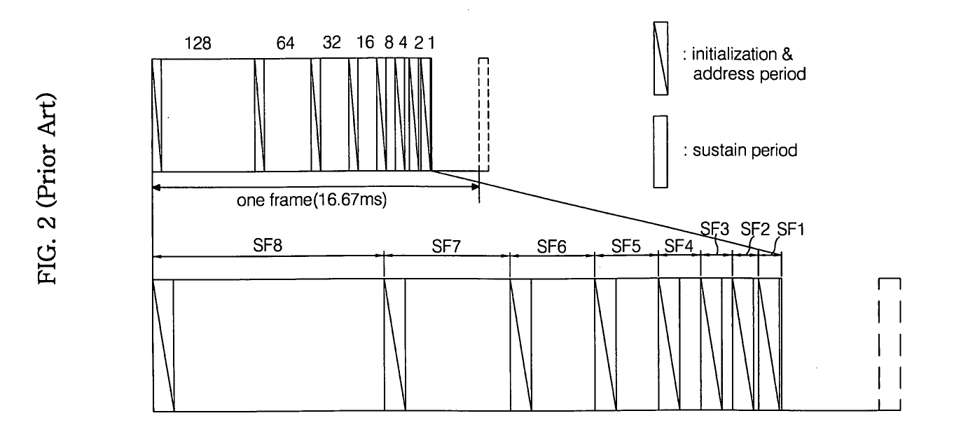

FIG. 3 is a driving waveform view of the general plasma display panel;

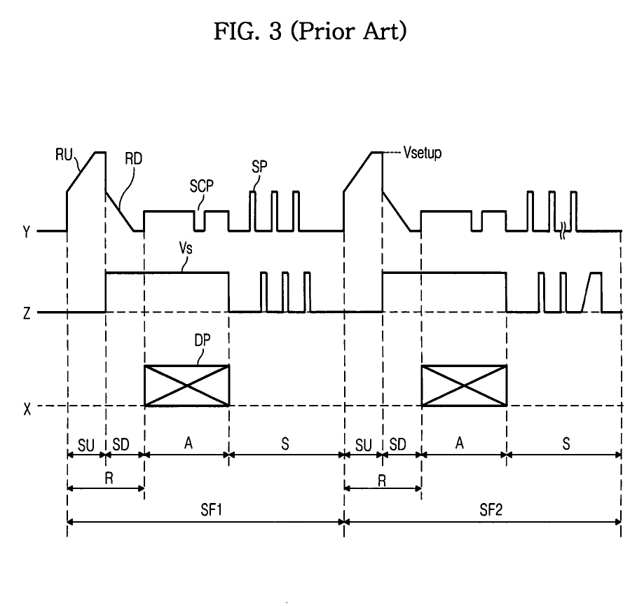

FIG. 4 shows an exemplary construction of an apparatus for driving a plasma display panel in accordance with a preferred embodiment of the present invention.

FIG. 5 is a driving waveform view of the plasma display panel in accordance with a first embodiment of the present invention.

FIG. 6 is a driving waveform view of the plasma display panel in accordance with a second embodiment of the present invention.

### DETAILED DESCRIPTION OF THE PREFERRED EMBODIMENT

A plasma display panel apparatus and driving waveforms additionally applying a reset rising waveform at a high temperature in accordance with the embodiment of the present invention will now be described with reference to the accompanying drawings.

There can be a plurality of embodiments of the plasma display panel in accordance with the present invention without being limited to those described in the present invention.

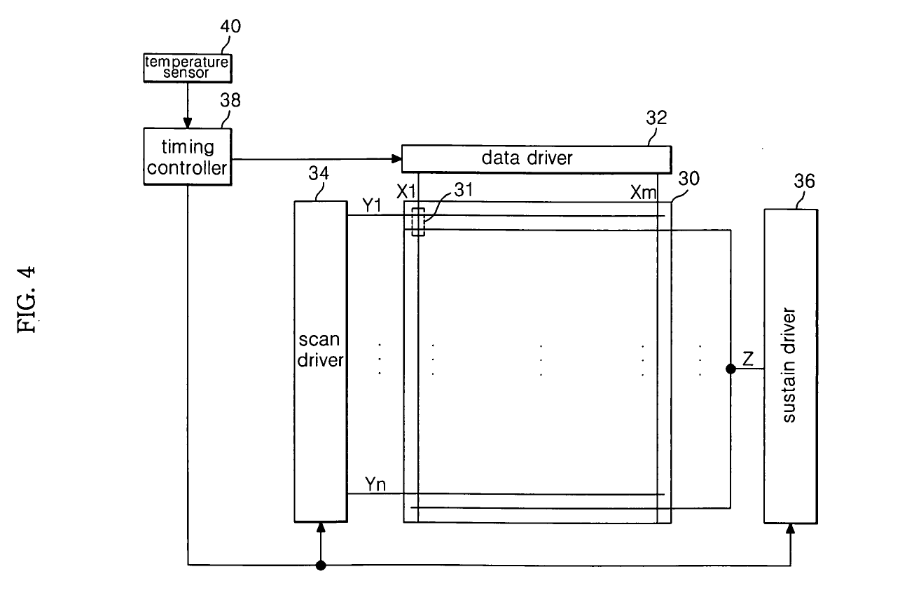

The preferred embodiment of the present invention will now be described with reference to FIGS. 4 to 6.

FIG. 4 illustrates an apparatus for driving a plasma display panel in accordance with the present invention.

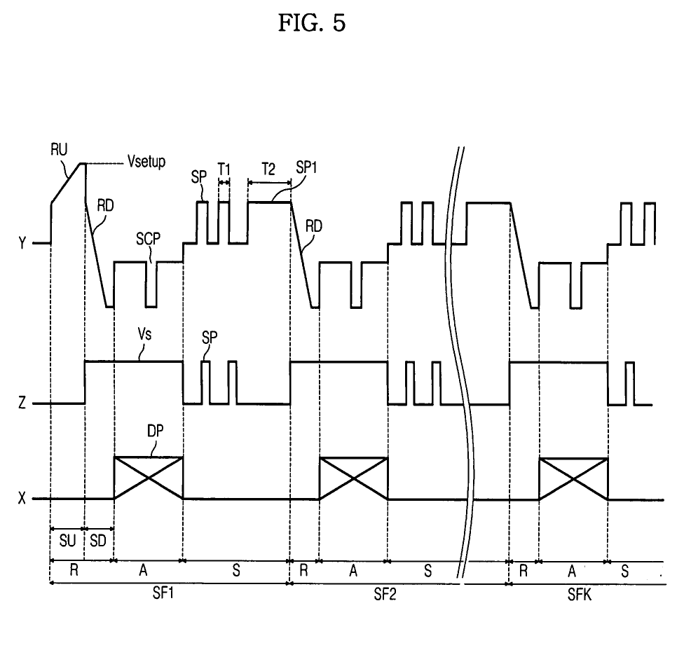

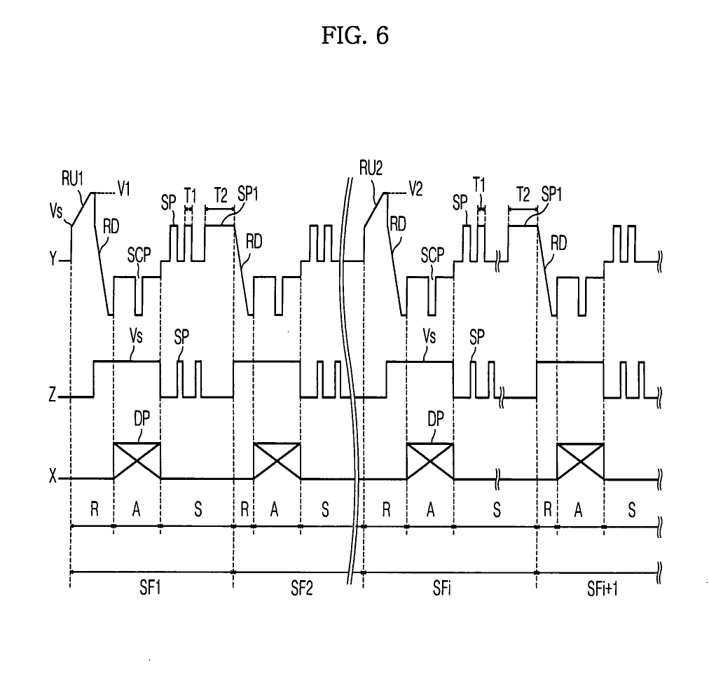

With reference to FIG. 4, the apparatus for driving the plasma display panel includes a panel 30, a data driver 32, a scan driver 34, a sustain driver 36, a data driver 32 for applying driving waveforms as illustrated in FIGS. 5 and 6 to compensate wall charges damaged when the plasma display panel is driven at a high temperature to thereby improve the contrast of the panel, a timing controller 38 for controlling a switch timing of the scan driver 34 and the sustain driver 36, and a temperature sensor 40.

The panel 30 includes a plurality of discharge cells 31 formed at crossings of a scan electrode (Y), a sustain electrode (Z) and an address electrode (X).

The data driver 32 supplies a data pulse to the address electrode (X) under the control of the timing controller 38.

The scan driver 34 supplies a reset rising waveform, a reset falling waveform, a scan pulse and a sustain pulse to the scan electrode (Y) under the control of the timing controller 38.

The sustain driver 36 supplies a positive DC voltage and a sustain pulse to the sustain electrode (Y) under the control of the timing controller 38.

The temperature sensor 40 senses temperature of the panel 30 and/or an ambient temperature of the panel 30, and supplies a value of the sensed temperature to the timing controller 38.

The timing controller 38 controls the switch timing of the data driver 32, the scan driver 34 and the sustain driver 36. In addition, the timing controller 38 controls a driving waveform supplied from the scan driver 34, namely, a driving waveform supplied during a reset period, corresponding to the temperature value provided from the temperature sensor 40.

In more detail, the timing controller is provided with the value of the temperature sensed by the temperature sensor 40. If the temperature sensed by the temperature sensor 40 is a reference temperature or lower, the timing controller 38 determines that it is a normal temperature and the scan driver 34 supplies the reset rising waveform during only the reset period of a first sub-field of one frame.

If, however, the temperature sensed by the temperature sensor 40 is greater than the reference temperature, the timing controller 38 determines that it is a high temperature and the scan driver 34 supplies the reset rising waveform to at least two or more sub-fields including the first sub-field among sub-fields included in one frame.

In this manner, in the apparatus for driving the plasma display panel, the driving waveforms illustrated in FIGS. 5 and 6 are supplied so that a discharge can occur stably even at a high temperature, and accordingly, the contrast of the panel can be improved.

FIG. 5 shows driving waveforms in accordance with a first embodiment of the present invention. The first embodiment of the present invention features that a reset rising waveform (RU) in a ramp form causing a setup discharge is supplied only to a first sub-field (SF1) of one frame and only a reset falling waveform (RD) is supplied to the other remaining sub-fields (SF2 to SFK) to thereby reduce emission of faint light according to the setup discharge and thus improve the contrast of the panel.

In one frame, the reset rising waveform (RU) which rises up to a setup voltage is simultaneously applied to every scan electrode (Y) during a setup time (SU) of the first sub-field (SF1). Accordingly, a setup discharge occurs in every discharge cell to thus generate wall charges in each discharge cell.

After the reset rising waveform (RU) is supplied, the reset falling waveform (RD), which falls from a sustain voltage (Vs) lower than a peak voltage of the reset rising waveform, is simultaneously applied to every scan electrode (Y). Then, unnecessary charges of the wall charges and space charges generated according to the setup discharge can be erased while only wall charges required for an address discharge can remain in the discharge cell.

During an address period (A), a negative scan pulse (SCP) is sequentially applied to the scan electrode (Y) and a positive data pulse (DP) in synchronization with the negative scan pulse is applied to the address electrode (X). Then, the address discharge occurs in the cell where the data pulse is applied according to a voltage difference between the scan pulse (SCP) and the data pulse (DP) and the wall charges generated during the setup period (SU).

Meanwhile, a certain positive DC voltage is supplied to the sustain electrode (Z) during a set-down period (SD), during which the reset falling waveform in the ramp form is applied to the scan electrode (Y), and the address period (A).

During a sustain period (S), a sustain pulse (SP) is alternately applied to the scan electrode (Y) and to the sustain electrode (Z), and a sustain discharge occurs in a surface discharge form between the scan electrode (Y) and the sustain electrode (Z). Herein, the number of sustain pulses (SP) supplied during the sustain period (S) is set corresponding to a luminance weight value of each sub-field.

During the sustain period (S), after the sustain pulse (SP) is supplied, the last sustain pulse (SP1) is supplied to the scan electrode (Y). In this case, in order to sufficiently form wall charges in the discharge cell, the last sustain pulse (SP1) is supplied for a longer time (T2) than a supply time (T1) of the other sustain pulse (SP).

When the final sustain discharge occurs in the first sub-field (SF1), the reset falling waveform (RD) in the ramp form, which falls from the high potential voltage (Vs) of the last sustain pulse (SP1), is simultaneously supplied to the scan electrode (Y) during a reset period (R) of the second sub-field (SF2).

That is, when the reset falling waveform (RD) is supplied to the scan electrode (Y), an erase discharge occurs in an ON cell in which the sustain discharge has occurred during the sustain period (S) of the first sub-field (SF1), and accordingly, the wall charges required for the address discharge can uniformly remain.

Meanwhile, in case of an OFF cell in which the sustain discharge has not occur during the sustain period (S) of the first sub-field (SF1), the wall charges formed during the setup period (SU) of the first sub-field are sustained, so little erase discharge occurs in the OFF cell according to the reset falling waveform (RD) of the second sub-field (SF2).

Thereafter, the same driving waveforms as those in the address period (A) and the sustain period (S) of the first sub-field (SF) are supplied during the address period (A) and the sustain period (S) of the second sub-field (SF), descriptions of which are thus omitted.

In the plasma display panel apparatus in which the driving waveforms according to the first embodiment of the present invention as illustrated in FIG. 5 are supplied, since light according to the setup discharge is generated only during the reset period of one sub-field (SF1) of one frame and light according to the setup discharge is not generated during the other remaining sub-fields, the contrast of the panel can be improved compared with that of the related art.

FIG. 6 shows driving waveforms in accordance with a second embodiment of the present invention. In the second embodiment of the present invention as shown in FIG. 6, the same driving waveforms as in the first embodiment are supplied, and in case of a high temperature, in order to compensate a loss of wall charges due to a leakage current, a first reset rising waveform (RU1) is supplied during a reset period of the first sub-field (SF1) and the second reset rising waveform (RU2) is additionally supplied during a reset period of the ith sub-field (SFi) to regenerate wall charges in each discharge cell to thereby improve the panel contrast.

First, when temperature of the panel or an ambient temperature of the panel is determined high, namely, it is higher than a reference temperature, the driving waveforms according to the first embodiment of the present invention are supplied during the first sub-field (SF1) and the following sub-fields (SF2 to SFi−1 and SFI+1).

In particular, the reset rising waveform (RU1) and the reset falling waveform 9RD) are applied during the reset period (R) of the first sub-field (SF1), and the reset rising waveform in this case is called a first reset rising waveform (RU1).

In addition, only the reset falling waveform (RD) is supplied during the reset period of the following sub-fields, to thereby minimize light emitted to outside the panel during the reset period (R), and thus, the panel contrast is improved.

In case of a high temperature, since the wall charges generated by the first reset rising waveform (RU1) are damaged due to the leakage current, a second reset rising waveform (RU2), which rises up to a second voltage (V2), is additionally supplied to every scan electrode (Y) during the reset period of the ith (i is a natural number of 3 or greater) sub-field (SFi).

Accordingly, the setup discharge occurs in every discharge cell by the second reset rising waveform (RU2) and wall charges are generated within the discharge cells, and thus, the wall charges damaged during the preceding sub-fields can be compensated.

That is, by supplying the second reset rising waveform (RU2) to every scan electrode (Y) during the reset period of the ith sub-field (SFi), the wall charges which have been re-combined or leaked at the high temperature can be generated again, and thus, the address discharge or the sustain discharge can occur stably and the contrast of the panel can be improved.

In addition, after the second reset rising waveform (RU2) is supplied during the reset period of the ith sub-field (SFi), the reset falling waveform (RD), which falls from a sustain voltage (Vs) lower than a peak voltage (V2) of the second reset rising waveform, is supplied to the scan electrode (Y) to erase unnecessary charges in the discharge cell to allow only wall charges required for the address discharge remain therein.

During the address period of the ith sub-field (SFi), the negative scan pulse (SCP) is sequentially applied to the scan electrode (Y), and at the same time, the positive data pulse (DP) is applied to the address electrode (X). As a voltage difference between the scan pulse (SCP) and the data pulse (DP) and the wall charges generated during the reset period are added, the address discharge occurs in the cell where the data pulse (DP) is applied. And accordingly, certain wall charges are generated by the address discharge in selected cells.

Meanwhile, a certain positive DC voltage is supplied to the sustain electrode (Z) during the set-down period (SD) during which the reset falling waveform (RD) is supplied and during the address period (A).

During the sustain period (S) of the ith sub-field (SFi), the sustain pulse (SP) is alternately applied to the scan electrode (Y) and the sustain electrode (Z), making a sustain discharge in a surface discharge form occur between the scan electrode (Y) and the sustain electrode (Z).

Thereafter, only the reset falling waveform (RD) is supplied during the reset period of the following certain sub-fields including the (i+1)th sub-field (SFi+1), to thereby minimize light generated during the reset period (R) and thus improve the contrast of the panel.

In the present invention, preferably, the voltage value (V2) of the second reset rising waveform is not greater than the first reset rising waveform.

Accordingly, the amount of light generated during the reset period ® of the ith sub-field (SFi) is the same as or smaller than the amount of light generated during the reset period of the first sub-field.

The highest voltage value (V2) of the second reset rising waveform is a voltage for compensating the wall charges damaged due to the high temperature during the sub-fields that follows the first sub-field, which can be determined by experimentation.

In the present invention, it is preferred that the sub-field (SFi) supplying the second reset rising waveform (RU2) is positioned after (following) the sub-field, among sub-fields of one frame, which represents the highest gray level.

In more detail, the sustain period of the sub-field representing the highest gray level of one frame is generally set to be the longest in the frame. Accordingly, when the panel is driven (operated) at the high temperature, there is a high probability that an erroneous discharge can occur in the sub-field positioned after (following) the sub-field representing the highest gray level in the frame.

Thus, in the present invention, by supplying the second reset rising waveform (RU2) during the reset period of the sub-field positioned after (following) the sub-field representing the highest gray level, a stable driving can be obtained. In addition, since the sub-field representing the highest gray level generates the most of light during the sustain period, the second reset rising waveform (RU2) is favored to be disposed following the sub-field representing the highest gray level to prevent degradation of the color contrast.

In the present invention, at least one or more sub-fields are set to supply the second reset rising waveform (RU2). If the second reset rising waveform (RU2) is supplied by two sub-fields, preferably, the sub-fields for supplying the second reset rising waveform (RU2) are positioned after (following) the sub-field representing the highest gray level and a sub-field representing the second-highest gray level in one frame.

As described above, in the plasma display panel apparatus and its driving method in accordance with the second embodiment of the present invention, when the panel is within a normal temperature range, the reset rising waveform is supplied only during the reset period of one sub-field, so the high contrast can be obtained. And when the plasma display panel is driven (operated) at a high temperature, the reset rising waveform is supplied to each reset period of at least two or more sub-fields, so that the contrast can be enhanced, and in addition, the plasma display panel can be driven (operated) in a stable manner even at the high temperature.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A method of driving a plasma display panel comprising:
increasing the number of reset rising waveforms applied during one frame when at least one of temperature of a panel and an ambient temperature of the panel increases.

2. The method of claim 1, wherein if a sensed temperature value is smaller than a certain reference temperature, the reset rising waveform is supplied only to a single sub-field of one frame.

3. The method of claim 2, wherein reference temperature value is 40° C.

4. The method of claim 2, wherein the reset rising waveform is supplied during a reset period of a first sub-field included in one frame.

5. The method of claim 2, wherein only a reset falling waveform is applied to the other remaining sub-fields than the sub-field to which the reset rising waveform is applied.

6. The method of claim 5, wherein the reset falling waveform falls at the last sustain waveform of a preceding sub-field.

7. The method of claim 1, wherein if the sensed temperature value exceeds the certain reference temperature value, a first reset rising waveform and a second reset rising waveform are applied to at least two or more sub-fields during one frame, respectively.

8. The method of claim 7, wherein the first reset rising waveform is applied to the first sub-field.

9. The method of claim 7, wherein the second reset rising waveform is applied to the sub-field that follows the sub-field representing the highest gray level, among the sub-fields included in one frame.

10. The method of claim 7, wherein the highest voltage level of the second reset rising waveform is smaller than the highest voltage level of the first reset rising waveform.

11. The method of claim 7, wherein only the reset falling waveform is applied to other remaining sub-fields than the sub-field to which the first and second reset rising waveforms are applied.

12. A method for driving a plasma display panel in which one frame is divided into at least one or more sub-fields according to time-division, comprising:
varying the number of reset rising waveforms applied during one frame corresponding to one of temperature of a panel and an ambient temperature of the panel.

13. The method of claim 12, wherein the number of reset rising waveforms applied when the temperature is not lower than a reference temperature is greater than the number of reset rising waveforms applied when the temperature is lower than the reference temperature.

14. A plasma display panel apparatus comprising:
a scan driving unit for increasing the number of reset rising waveforms applied during one frame when either temperature of a panel or an ambient temperature of the panel is higher than a certain reference temperature, so that the number of the reset rising waveforms can be greater than that of a case where the temperature of the panel or the ambient temperature of the panel is not higher than the reference temperature level.

15. The apparatus of claim 14, wherein when the sensed temperature value is not greater than the certain reference temperature value, the scan driving unit applies the reset rising waveform only to the first sub-field of a unit frame.

16. The apparatus of claim 14, wherein when the sensed temperature value is greater than the reference temperature value, the scan driving unit applies the first and second reset rising waveforms during each reset period of the first sub-field and at least one or more sub-fields except the first sub-field of the unit frame.

17. The apparatus of claim 16, wherein the second reset rising waveform is supplied to the sub-field that follows the sub-field having the highest gray level among the sub-fields included in one frame.

18. A plasma display panel apparatus comprising:
a panel having at least one or more electrodes; and
a scan driving unit for supplying a reset rising waveform and a reset falling waveform during only a reset period of one of sub-fields of one frame, and supplying only the reset falling waveform during a reset period of the other remaining sub-fields.

19. The apparatus of claim 18, wherein the sub-field to which the reset rising waveform is applied is the first sub-field of the frame.

20. The apparatus of claim 18, wherein the last sustain waveform of a preceding sub field during which the reset falling waveform is applied has a longer high potential sustain period than that of other sustain waveforms.
